(19) United States
(12) Patent Application Publication
(10) Pub. No.: US 2006/0254056 A1
(43) Pub. Date: Nov. 16, 2006

(54) Shaving device with shaving aid material dispenser

(75) Inventors: David C. Coffin, Hamden, CT (US); Raymond Guimont, Guilford, CT (US)

Correspondence Address: Richard R Michaud;The Michaud-Duffy Group, LLC, 306 Industrial Park Road, Suite 206, Middletown, CT, 06457, US

(73) Assignee: Eveready Battery Company, St. Louis, MO (US)

(21) Appl. No.: 10/966,005

(22) Filed: Oct. 15, 2004

Related U.S. Application Data
(60) Provisional application No. 60/512,475, filed on Oct. 17, 2003.
(60) Provisional application No. 60/512,474, filed on Oct. 17, 2003.

(51) Int. Cl. B26B 19/44

(52) U.S. Cl. 30/41; 30/50

(57) ABSTRACT

The present invention provides a shaving device that includes a razor cartridge and a handle. The razor cartridge includes one or more razor blades and a liquid material storage element disposed within a reservoir. A dispensing medium extends between the liquid material storage element and an outer surface of the razor cartridge. During the act of shaving, the dispensing medium operates to draw the liquid from the reservoir to a user contact end of the dispensing medium, where the liquid is the applied to the area being shaved adjacent to the cutting edge(s).

This application is entitled to the benefit of and incorporates by reference essential subject matter disclosed in U.S. Provisional Patent Application Nos. 60/512,475 and 60/512,474, both filed on Oct. 17, 2003.

### BACKGROUND OF THE INVENTION

1. Technical Field

The present invention relates to shaving devices that include apparatus for dispensing liquid or gel shaving aid material in general, and to shaving devices that include the aforesaid apparatus within a razor cartridge portion of the shaving device in particular.

2. Background Information

Conventional safety razors typically include a disposable razor cartridge mounted in a reusable handle, or a handle and cartridge combined into a unitary disposable unit. Most razor cartridges include a frame, at least one razor blade, and a strip of shaving aid material attached to the frame. Shaving aid materials include, but are not limited to lubricating agents, drag reducing agents, depilatory agents, cleaning agents, medicinal agents, and the like that enhance the shaving process. The strip of shaving aid material is typically attached to the razor cartridge adjacent to the razor blade(s). An additional shaving aid material (e.g., a shaving cream) is also typically used with the razor cartridge.

Shaving aid material strips typically comprise a water-soluble material that is intended to be dispensed during the act of shaving, and a water-insoluble material that is not intended to be dispensed during shaving. The water-insoluble material provides a medium for supporting and/or holding the water-soluble material. An example of a water-insoluble material is a polystyrene, and an example of a water-soluble material is a polyox-type material. Both of these types of materials are well known in the art.

Several disadvantages are often associated with some shaving aid strips. For example, the useful life of shaving aid strips can vary significantly depending on the shaving habits of the user, and the environment in which the razor cartridge is being used and/or stored. The amount of shaving aid material being dispensed can also vary over the life of the shaving device. Consequently, an initially adequate dispersion rate may subsequently become inadequate. In addition, the types of shaving aid material that can be dispensed in a shaving aid strip are limited.

Therefore, it would be desirable to provide a shaving device that overcomes these shortcomings in the art.

### DISCLOSURE OF THE INVENTION

According to the present invention, a shaving device includes a handle and a razor cartridge. The razor cartridge includes one or more razor blades and a reservoir. A liquid material storage element is disposed within the reservoir. A dispensing medium extends between the liquid material storage element and an outer surface of the razor cartridge. A contact end of the dispensing medium is disposed adjacent the outer surface. The dispensing medium is operable to draw a liquid stored within the liquid material storage element, through the dispensing medium, and to the contact end. In some embodiments, the reservoir also includes a selectively removable lid.

According to an aspect of the present invention, a replacement razor cartridge for use with a handle includes one or more razor blades, a reservoir, a liquid material storage element, and a dispensing medium.

According to another aspect of the present invention, the liquid storage medium is either itself a replaceable cartridge, or is contained within a replaceable cartridge, that engages with the razor cartridge.

An advantage of the present invention is that the shaving device of the present invention provides a user with a selectively renewable source of shaving aid.

Another advantage of the present invention is that the shaving device is that a single shaving device is adaptable to being used with a wide variety of shaving aids.

Another advantage of the present invention is that the surface to be shaved can be coated with a pre-shave, mid-shave, or post-shave preparation to facilitate the shaving process, and increase the comfort of the shaving process.

Another advantage of the present invention is that a shaving aid delivery system is provided that is operable at all angles and positions. Shaving aid can be supplied to the skin surface even if the razor assembly is upside-down, tilted to one-side, or in any unusual position, at least until the supply of liquid shaving aid preparation is completely depleted.

These and other objects, features, and advantages of the present invention will become apparent in light of the detailed description of the present invention.

### BRIEF DESCRIPTION OF THE DRAWINGS

FIG. 1 is a sectional side view of one embodiment of the shaving device of the present invention.

FIG. 1A is a side, partial sectional view of another embodiment of the shaving device of the present invention.

FIG. 2 is a top view of the razor cartridge of the present invention.

FIG. 3 is an enlarged view of Section 3 of FIG. 1.

FIG. 4 is a perspective view of the razor cartridge of the present invention with the selectively removable lid removed.

FIG. 5 is a perspective view of the liquid material storage element of the present invention.

FIG. 6 is a top view of the dispensing medium of the present invention.

FIG. 7 is a side view of the dispensing medium of the present invention.

FIG. 8 is a perspective view of the selectively removable lid of the present invention.

FIG. 9 is a diagrammatic view of an embodiment of the present invention shaving device.

FIG. 10 is a diagrammatic sectional view of an embodiment of the present invention razor cartridge.

FIG. 11 is a diagrammatic sectional view of an embodiment of the present invention razor cartridge.

FIG. 12 is a diagrammatic perspective exploded view of an embodiment of the present invention razor cartridge.

FIG. 13 is a diagrammatic perspective view of an embodiment of the present invention dispensing medium.

FIG. 14 is a diagrammatic sectional view of an embodiment of the present invention dispensing medium.

FIG. 15 is a diagrammatic sectional view of an embodiment of the present invention razor cartridge.

FIG. 16 is a diagrammatic sectional view of an embodiment of the present invention razor cartridge.

### DETAILED DESCRIPTION OF THE INVENTION

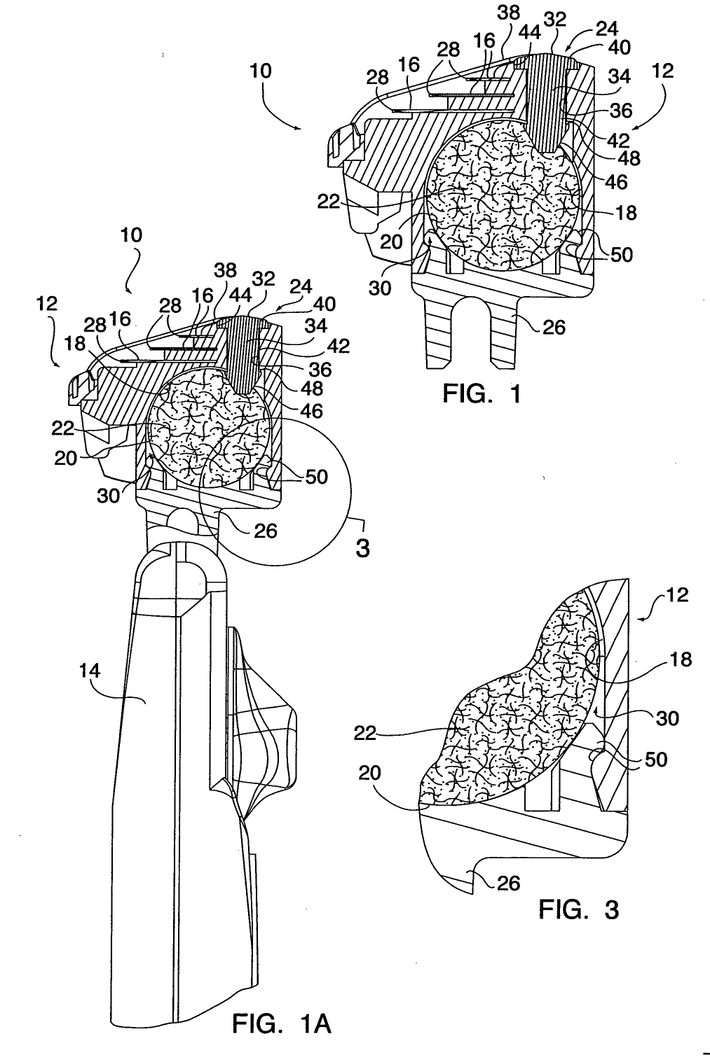

Referring now to FIGS. 1-16, embodiments of the shaving device 10 of the present invention are shown. The shaving device 10 includes a razor cartridge 12 and a handle 14. The handle 14 may be fixedly or pivotally attached to the razor cartridge 12. In some embodiments, the razor cartridge is selectively attachable/detachable to the handle and is a replaceable unit. The handle 14 may be made of any suitable material and shaped in any suitable manner. The razor cartridge 12 includes one or more razor blades 16, a reservoir 18, a liquid material storage element 20, and a dispensing medium 24. The razor blade(s) 16 have at least one cutting edge 28. Preferably, the razor blade(s) 16 are molded into the razor cartridge 12, as is a well-known method in the art for mounting razor blade(s) 16 in a razor cartridge 12. However, the razor blade(s) 16 may be mounted in the razor cartridge 12 in any suitable manner.

Now referring to the embodiments shown in FIGS. 1-8, the reservoir 18 is formed within the razor cartridge 12. The reservoir 18 may be of any suitable shape. However, a reservoir 18 sized and shaped in complimentary manner to the liquid material storage element 20 (discussed infra.) is preferred. The reservoir 18 includes an open end 30 that allows the user to selectively insert and remove the liquid material storage element 20 from the reservoir 18.

Referring to FIG. 5, the liquid material storage element 20 may be of any shape that passes though the open end 30 and substantially fills the reservoir 18. The liquid material storage element 20 shown in FIG. 5, for example, is cylindrical in shape. In some embodiments, the liquid material storage element 20 is made of a fibrous material. Acetate is an example of an acceptable liquid material storage element 20. Additional acceptable examples of the liquid material storage element are provided infra.

A liquid shaving aid material 22 is distributed within the liquid material storage element 20. The liquid 22 may be distributed in the liquid material storage element 20 prior to placing the liquid material storage element 20 into the reservoir 18. Alternatively, the liquid material storage element 20 may be placed in the reservoir 18 and the liquid 22 then distributed in the liquid material storage element 20. For example, inserting a needle into the liquid material storage element 20 and injecting the liquid 22 is one acceptable method. Acceptable liquid shaving aid materials 22 include, but are not limited to, lubricating agents, drag reducing agents, depilatory agents, cleaning agents, medicinal agents, soap materials, and the like, including combinations thereof, that enhance the shaving process.

Referring to FIGS. 1, 6 and 7, the dispensing medium 24 is operable to draw the liquid 22 stored within the liquid material storage element 20 in the reservoir 18, through the dispensing medium 24, and to a contact end 32 by capillary action. The term “capillary action,” as used herein, refers to the natural drawing action of a non-solid through a medium or within a passage caused by adhesive and cohesive forces. In some embodiments, a tube with an appropriately sized diameter is used as a part of the dispensing medium 24 to draw liquid from the reservoir via capillary action.

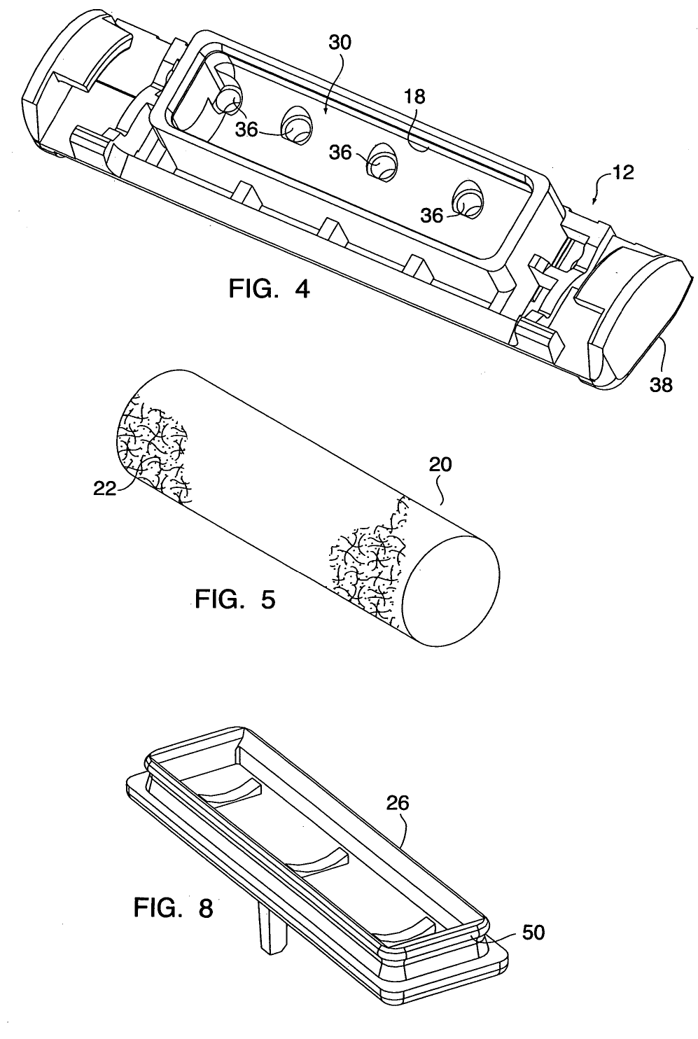

In other embodiments of the present invention, the dispensing medium 24 includes a wick 34 made of fibrous, porous, sintered plastic, or similar type material. Specific examples of dispensing medium are provided infra. In these embodiments, the razor cartridge 12 includes at least one aperture 36 within an outer surface 38 of the razor cartridge 12 (as shown in FIG. 4). The wick 34 is positioned in the aperture 36 such that the contact end 32 of the wick 34 is adjacent to, or protruding through, the outer surface 38 of the razor cartridge 12. Referring now to FIG. 1, the contact end 32 of the wick 34 preferably protrudes from the outer surface 38 of the razor cartridge 12 at a location that is proximate to the cutting edge(s) 28 of the razor blade(s) 16. A portion of the wick 34 is also adjacent, or extends into, the reservoir 18 and is in direct contact with the liquid material storage device 20.

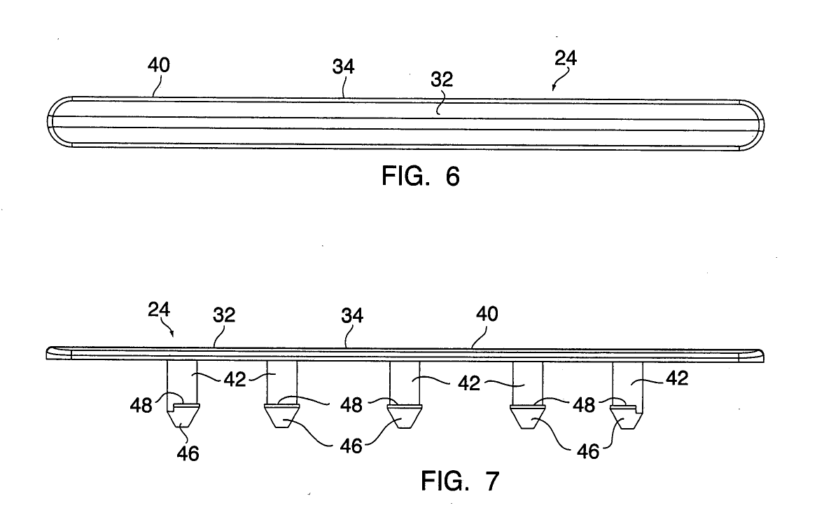

Referring to FIGS. 6 and 7, in some embodiments, the wick 34 has an elongated body portion 40 and a plurality of pins 42. The elongated body 40 is placed in a channel 44 formed in the outer surface 38 of the razor cartridge 12 (as shown in FIG. 1). The pins 42 are inserted into a plurality of complimentary apertures 36 (see FIGS. 4, 6, and 7) that lead from the outer surface 38 of the razor cartridge 12 to the reservoir 18. Each of the pins 42 additionally contains a tip 46 that has an outwardly protruding lip 48 shaped to allow the pin 42 to pass through the aperture 36, extend into the reservoir 18, and lock the wick 34 in place. The lip 48 maintains the position of the elongated body portion 40 of the wick 34 in the channel 44 and ensures that at least one pin 42 maintains contact with the liquid material storage element 20 in the reservoir 18.

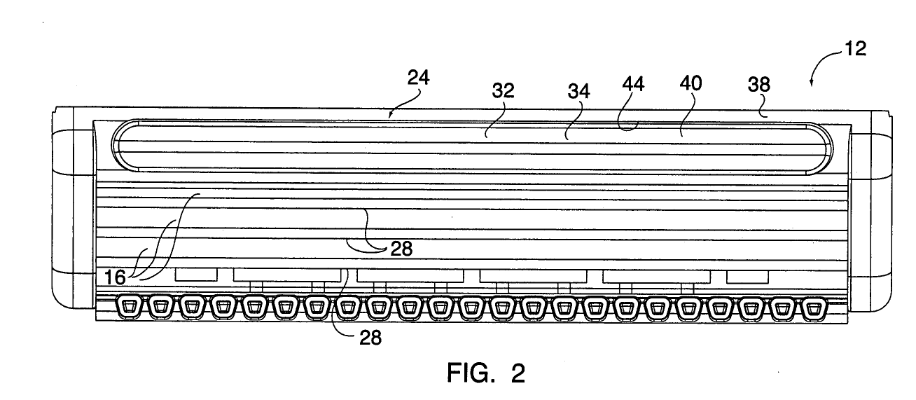

Referring to the embodiments shown in FIGS. 1, 1A, 3 and 8, the razor cartridge includes a selectively removable lid 26. In the embodiment shown in FIG. 1A, the handle 14 is mounted to the selectively removable lid 26. The selectively removable lid 26 is sized to at least substantially cover the open end 30 of the reservoir 18. In a preferred embodiment, the open end 30 of the reservoir 18 and the selectively removable lid 26 also includes complimentary connectors 50 that enable the selectively removable lid 26 to completely cover and seal the open end 30 of the reservoir 18. The complimentary connectors 50 shown in FIGS. 1 and 2 are a mating pair. Other mating pairs, clips, or the like may be used alternatively to connect the selectively removable lid 26 and the open end 30 of the reservoir 18. The selectively removable lid 26 and the reservoir 18 may also be pivotally connected to one another.

The present invention is described above in terms of a shaving device 10 having a razor cartridge 12 and a handle 14. In some applications, the razor cartridge 12 is releasably attached to the handle 14 to permit the handle 14 to be used more than once with different razor cartridges 12.

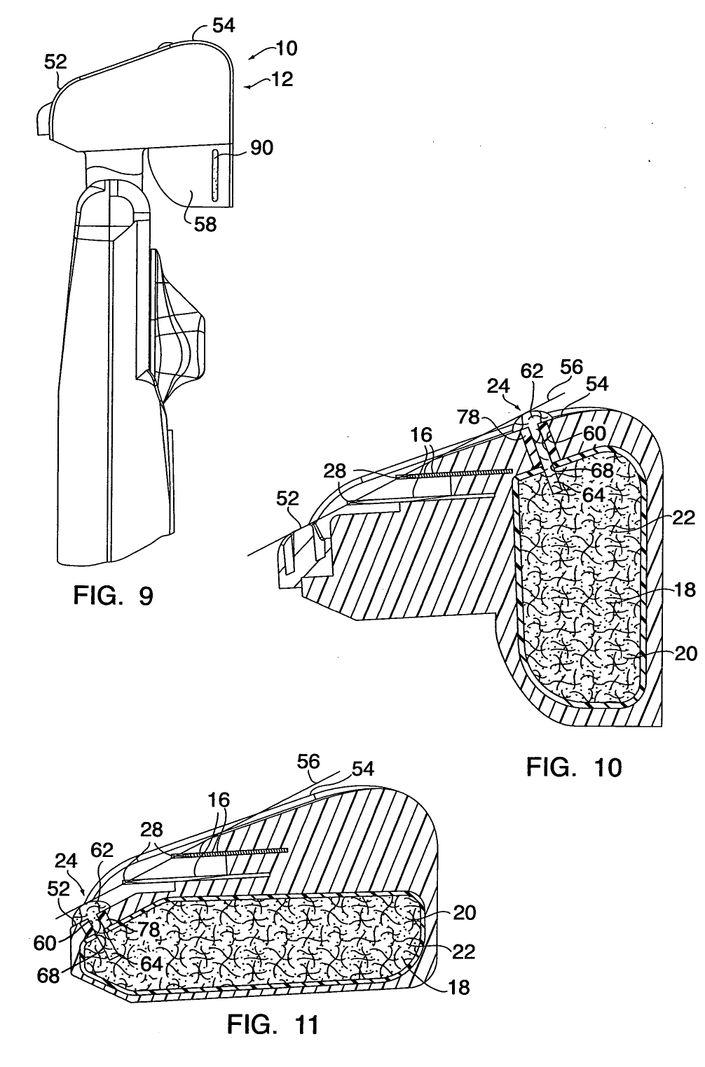

Now referring to the embodiments shown in FIGS. 9-16, the present invention shaving device 10 includes a razor cartridge 12 having a leading surface 52, a trailing surface 54, a shave plane 56 extending between the leading surface 52 and the trailing surface 54, and a reservoir 18. The reservoir 18 is capable of retaining and storing a sufficient volume of liquid shaving aid material 22, preferably corresponding to the desired life for the razor blades 16. Though shown as being part of the structure of the razor cartridge 12 itself, the reservoir 18 can take the form of a separate housing 58 attachable to the razor cartridge 12, which housing 58 may be replaceable to replenish the supply of liquid shaving aid material 22, or to switch to a different shaving aid material, as desired. The replaceable housing 58 shown in FIG. 9 defines a reservoir 18 that is attachable/detachable from the razor cartridge 12. The reservoir 18 may be installed pre-impregnated with liquid shaving aid material 22, or it may be adaptable to being refilled with liquid shaving aid material 22.

A liquid material storage element 20 that stores the liquid shaving aid material 22 is provided in the reservoir 18, preferably substantially filling the interior volume thereof. The liquid material storage element 20 communicates with a dispensing medium 24 mounted in the razor cartridge 12, and, in combination, they provide a structure operable to deliver liquid shaving aid material 22 to the user's skin. The liquid material storage element 20 may be a fibrous structure forming a porous strip with pore sizes of about 5 to 120 microns and pore volumes of about 25%-95%. Porous polymers such as polypropylene or other polyolefin binders, oriented polyester, or other fiber component blends are examples of acceptable storage element materials. The fibers forming the strip can be treated to provide for hydrophobic or hydrophilic surface reactivity.

The dispensing medium 24 is disposed in a slot 60 in the razor cartridge 12 so that a first portion 62 projects outwardly from the razor cartridge 12 to expose the dispensing medium 24 to the user's skin during a shaving operation. A second portion 64 of the dispensing medium 24 extends into the reservoir 18 and communicates with the liquid material storage element 20. The dispensing medium 24 can itself be constructed of a shaving aid material, which, in combination with the absorbed liquid shaving aid material 22, can be applied to the user's skin during shaving. Examples of acceptable dispensing medium 24 materials include porous or other capillary-type material such as high-density polyethylene (HDPE), polytetrafluoroethylene (PTFE), ultra-high molecular weight polyethylene (UHMW), nylon6 (N6), polypropylene (PP), polyvinylidene fluoride (PVDF), polyethersulfone (PES), or other polymer formulations, as well as porous metals, ceramics, membranes or other filtration materials. Alternatively, the dispensing medium 24 can be a fibrous structure.

As shown in FIGS. 10 and 12-14, the second portion 64 of the dispensing medium 24 comprises a plurality of legs 66 that extend into the reservoir 18 for engagement with the liquid material storage element 20. In some embodiments, the legs extend through apertures 68 in the bottom of the slot 60. The legs 66 engage the apertures 68 and attach the dispensing medium 24 within the slot 60. Additionally, the legs 66 facilitate the transfer (e.g., via capillary or wicking action) of liquid shaving aid material 22 to and throughout the dispensing medium 24. The liquid shaving aid material 22 is then evenly dispersed through the dispensing medium 24.

Liquid shaving aid material 22 is applied to the user's skin surface by contact between the dispensing medium 24 and the skin surface during a shaving operation. The rate at which the shaving aid is delivered to the user's skin surface is controlled, in part, by the size of capillary voids in the dispensing medium 24, the volume of the dispensing medium 24, and the viscosity, surface tension and wetting or spreading coefficient (creep) of the liquid shaving aid material 22.

In an alternate design shown in FIG. 15, the liquid material storage element 20 and a dispensing medium 24 can be replaced by a unitary structure 70. A first portion 72 of the unitary structure 70 is partially exposed from the razor cartridge 12, and a second portion 74 substantially fills the reservoir 18 and absorbs liquid shaving aid material 22 provided therein. Though formed in one-piece, the first portion 72 and the second portion 74 can be divided into a respective low-void area and a high-void area, separated by a transition zone 76. The low void area is operable to control the distribution of liquid shaving aid material 22 through the exposed portion of the first portion 72, and the high void area is operable to store and pass the liquid shaving aid material 22 from the second portion 74 into the first portion 72.

In some embodiments, one or more seals 78 are used to inhibit or prevent evaporation of shaving aid material 22 from the reservoir 18.

The location and position of the dispensing medium 24 on the razor cartridge 12 can be changed to suit different applications. FIGS. 10, 12, and 15 show the dispensing medium 24 positioned aft of the razor blades 16. FIG. 11, in contrast, shows the dispensing medium 24 positioned forward of the razor blades 16.

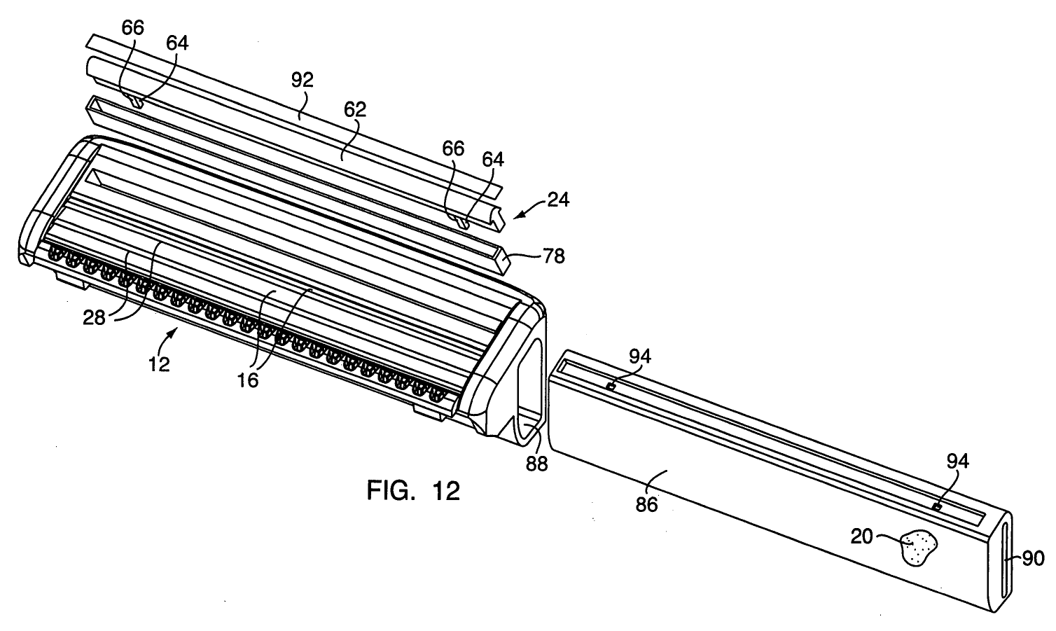

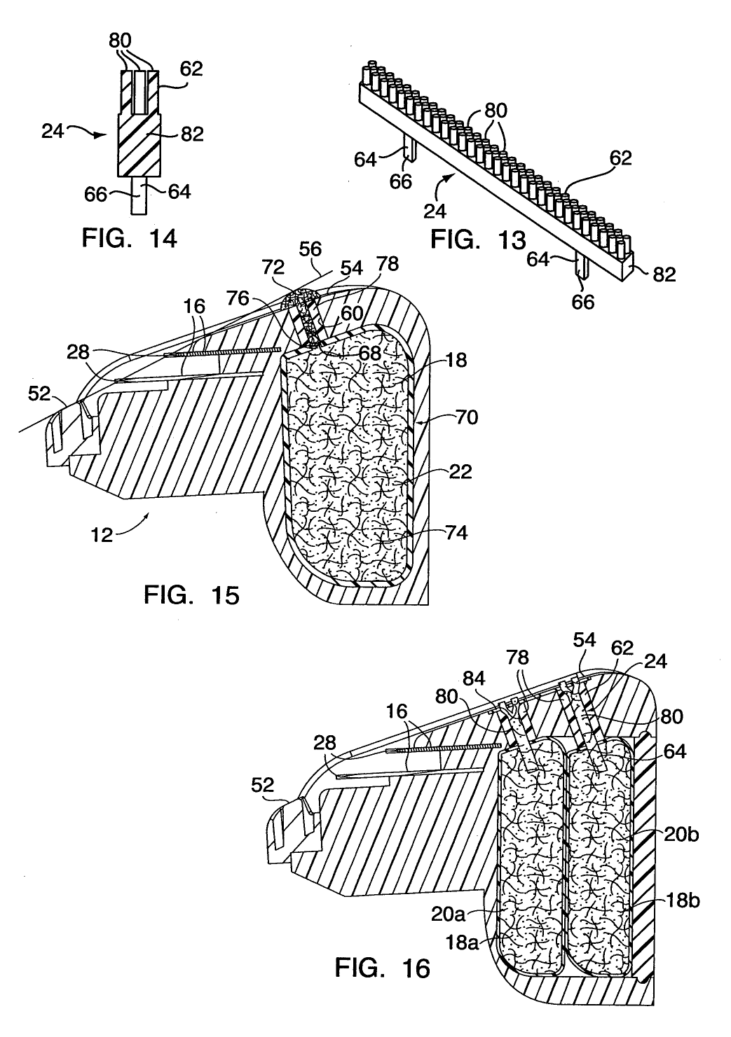

The dispensing medium 24 preferably extends across the width of the razor cartridge 12 so as to maximize the area over which shaving aid material 22 may be applied. The first portion 62 of the dispensing medium 24 need not be a continuous structure as shown in FIG. 12, however. For example, as shown in FIGS. 13, 14, and 16, the dispensing medium 24 can comprise an array of shaped members 80 (e.g., rods, bristles or other protrusions) adapted to extend outside of the razor cartridge 12 to engage the surface of the user's skin. The shaped members 80 can extend outwardly from a continuous dispensing medium base member 82 (see FIGS. 13 and 14). Alternatively, the dispensing medium 24 can actually comprise multiple individual shaped members 80, as illustrated in FIG. 16.

In some embodiments, the shaped members 80 are operable to meter the amount and position of shaving aid material 22 flow. For example, the flow of shaving aid material 22 can be controlled by the volume, cross-section and surface area of the shaped members 80, the number of shaped members 80, and the arrangement of the shaped members 80. Shaped members 80 can be used to connect the dispensing medium 24 to several partitioned reservoirs 18a, 18b (see FIG. 16) each containing a different of shaving aid material 22 and in some instances a different liquid material storage element 20a, 20b as well. Where desired, such shaped members 80 can be routed and intertwined from the respective reservoirs 20 in such a manner so as to provide a desirable distribution of different shaving aid materials 22 through the surface of the razor cartridge 12. As shown in FIG. 16, shaped members 80 are routed between the reservoir 18 and a cover plate 84 adapted to position the ends of the members 80 for contact with the user's skin.

The liquid material storage element 20 of the present invention may be replaceable within the razor cartridge 12 after the supply of liquid shaving aid material 22 in the reservoir 18 has been depleted. For example, as shown in FIG. 12, the liquid material storage element 20 may be contained within a separate container 86 that may be inserted into the reservoir cavity 88 in the razor cartridge 12, or otherwise attached thereto, and may be subsequently removed from the razor cartridge 12 and replaced or refilled. The container 86 can have one or more openings 94 that receive the legs 66 of the dispensing medium 24 to maintain contact between the dispensing medium 24 and the liquid material storage element 20 in the container 86. The legs 66 can operate to hold the container 86 in place within the reservoir cavity 88 during shaving. The container 86 can also be provided with alternate or additional locking means (not shown) to hold it in place in the cavity 88. Though illustrated in a particular embodiment in FIGS. 5 and 6, the container 86 and cavity 88 can take any shape, volume or design. Alternatively, means for accessing the reservoir 18 may be provided so that the reservoir 18 can be refilled with liquid shaving aid material 22.

The amount of shaving aid material 22 provided with the liquid material storage element 20 may correlate to the expected life of the razor blades 16 so that when the supply of liquid shaving aid material 22 is exhausted, the user will know that the blades 16 are worn and the razor cartridge 12 needs to be replaced. Several methods of gauging the supply of liquid shaving aid material 22 may also be used with the present invention; e.g., a transparent reservoir 18, a sight glass 90 incorporated into the reservoir design, a colored shaving aid material 22, electrical circuitry that detects the reduction of conductivity of the absorbent material indicative of depletion of the shaving aid material, etc.

In order to prevent the artificial evaporation of the liquid shaving aid material, a protective film or cover 92 (see FIG. 12) may be provided over the dispensing medium 24 when the device 10 is not in use.

In operation, the shaving device 10 is brought into contact with the surface to be shaved. As the user moves the shaving device 10 along the surface, the dispensing medium 24 draws liquid shaving aid material 22 from the liquid material storage element 20 in the reservoir 18. The liquid is drawn through the dispensing medium 24, to the contact end 32 (or first portion 62), where the liquid 22 is then applied to the surface being shaved adjacent to the cutting edge(s) 28. Simultaneously, as the user moves the shaving device 10 across the surface, the cutting edge(s) 28 of the razor blade(s) 16 shave undesired hair from the area.

After repeated use and upon expending at least a portion of the liquid 22 distributed in the liquid material storage element 20, the user may distribute additional liquid 22 into the liquid material storage element 20 disposed in the reservoir 18. Alternatively, the user may replace the liquid material storage element 20 in the reservoir 18 with a new liquid material storage element 20 (e.g., cartridge 86) containing liquid shaving aid material 22.

Although this invention has been shown and described with respect to the detailed embodiments thereof, it will be understood by those of skill in the art that various changes may be made and equivalents may be substituted for elements thereof without departing from the scope of the invention. The present invention is not, therefore, intended to be limited to the particular embodiments disclosed in the above detailed description, but that the invention will include all embodiments falling within the scope of the appended claims.

What is claimed is:

1. A shaving device, comprising:
a handle;
a razor cartridge attached to the handle, the razor cartridge having one or more razor blades, a reservoir with a selectively removable lid, a liquid material storage element disposed within the reservoir, and a dispensing medium extending between the storage element and an outer surface of the razor cartridge, the dispensing medium having a contact end;
wherein the dispensing medium is operable to draw liquid stored within the liquid material storage element, through the dispensing medium to the contact end.

2. The shaving device of claim 1 wherein the handle is permanently attached to the razor cartridge.

3. The shaving device of claim 1 wherein the handle is attached to the selectively removable lid.

4. The shaving device of claim 1 wherein the handle is selectively attachable to the razor cartridge.

5. The shaving device of claim 4 wherein the handle is selectively attachable to the selectively removable lid.

6. The shaving device of claim 1 wherein the selectively removable cover is sized to completely cover the open end of the reservoir when positioned over the open end.

7. The shaving device of claim 6 wherein the selectively removable cover substantially seals the open end of the reservoir when positioned over the open end.

8. The shaving device of claim 1 wherein the liquid material storage element is selectively replaceable.

9. The shaving device of claim 8 wherein the dispensing medium is a wick.

10. The shaving device of claim 9 wherein the wick is a porous material.

11. The shaving device of claim 9 wherein the wick is a sintered plastics material.

12. The shaving device of claim 9 wherein the wick has an elongated body portion that is seated in a channel formed in the razor cartridge and a plurality of pins that are positioned in complimentary apertures in the razor cartridge.

13. The shaving device of claim 12 wherein at least one pin is further characterized by a tip having an outwardly extending lip to allow the wick to pass through the aperture, protrude into the reservoir and snap into place, maintaining the position of the elongated body in the channel.

14. The shaving device of claim 13, wherein at least one of the pins is in contact with the liquid material storage element.

15. A replacement cartridge for shaving device, comprising:
one or more razor blades;
a reservoir with a selectively removable lid; and
a dispensing medium extending between the reservoir and an outer surface of the razor cartridge, the dispensing medium having a contact end disposed adjacent the outer surface;
wherein the dispensing medium is operable to draw liquid from the reservoir to the contact end.

16. The shaving device of claim 15 wherein the selectively removable lid is sized to completely cover the open end of the reservoir.

17. The shaving device of claim 16 wherein the selectively removable lid substantially seals the open end of the reservoir when positioned over the open end of the reservoir.

18. The shaving device of claim 17 wherein the liquid material storage element is selectively replaceable.

19. The shaving device of claim 18 wherein the liquid material storage element is a wick.

20. The shaving device of claim 19 wherein the wick is a porous material.

21. The shaving device of claim 19 wherein the wick is a sintered plastics material.

22. The shaving device of claim 19 wherein the wick has an elongated body portion that is seated in a channel formed in the razor cartridge and a plurality of pins that are positioned in complimentary apertures in the razor cartridge that lead to the reservoir.

23. The shaving device of claim 19 wherein at least one pin is further characterized by a tip having an outwardly extending lip to allow the wick to pass through the aperture, protrude into the reservoir and snap into place, maintaining the position of the elongated body in the channel.

24. The shaving device of claim 23, wherein at least one of the pins is in contact with the liquid material storage element.

25. A razor cartridge having a shaving aid delivery system, comprising:
a reservoir for storing liquid shaving aid material therein;
at least one razor blade having a cutting edge that is at least partially exposed;
a liquid material storage element disposed in the reservoir;
a dispensing medium having a first portion that is at least partially exposed and projects outwardly from the razor cartridge, and a second portion communicating with the liquid material storage element to receive liquid shaving aid material therefrom via a wicking action; and
wherein liquid shaving aid material is applied to a user's skin in response to contact between the user's skin and the dispensing medium.

26. The razor cartridge of claim 25, wherein the cartridge comprises:
a plurality of reservoirs, each having a portion of the liquid material storage element disposed therein; and
a plurality of dispensing mediums, wherein at least one of the plurality of dispensing mediums extends between the exterior of the razor cartridge and a first of the plurality of reservoirs, and at least another of the plurality of dispensing mediums extends between the exterior of the razor cartridge and a second of the plurality of reservoirs.

27. The razor cartridge of claim 25, wherein the liquid material storage element and the dispensing medium are integrally connected.

28. The razor cartridge of claim 25, wherein the dispensing medium substantially extends over the width of the razor cartridge.

29. The razor cartridge of claim 28, wherein the dispensing medium substantially extends parallel to the cutting edge of the at least one blade.

30. The razor cartridge of claim 25, wherein the first portion of the dispensing medium projects outwardly from the housing at a position adjacent the at least one razor blade.

31. The razor cartridge of claim 30, wherein the dispensing medium is positioned in the housing aft of the razor blades.

32. The razor cartridge of claim 30, wherein the dispensing medium is positioned in the housing forward of the razor blades.

33. A razor assembly comprising:
a handle; and
a razor cartridge attached to said handle, said razor cartridge including
at least one razor blade having a cutting edge that is at least partially exposed from said razor cartridge;
a reservoir for storing a liquid shaving aid preparation;
a liquid material storage element disposed in the reservoir for absorbing the liquid shaving aid preparation;
an elongated dispensing medium having a first portion that is at least partially exposed and projects outwardly from the housing, and a second portion communicating with the liquid material storage element to receive liquid shaving aid material therefrom via a wicking action.

34. A replacement cartridge, comprising:
a container;
a liquid material storage element disposed in the container; and
a dispensing medium having a first portion extending out from the container and a second portion in communication with the liquid material storage element.

35. The replacement cartridge of claim 34, wherein the container includes elements operable to attach the container to a razor cartridge.
